(19) United States
(12) Patent Application Publication
(10) Pub. No.: US 2008/0132432 A1
(43) Pub. Date: Jun. 5, 2008

(54) ADDITIVES AND LUBRICANT FORMULATIONS FOR PROVIDING FRICTION MODIFICATION

(76) Inventors: Naresh C. Mathur, Midlothian, VA (US); William Y. Lam, Glen Allen, VA (US)

Correspondence Address: LUEDEKA, NEELY & GRAHAM, P.C., P O BOX 1871, KNOXVILLE, TN, 37901, US

(21) Appl. No.: 11/565,796

(22) Filed: Dec. 1, 2006

(51) Int. Cl. F16C 33/04

(52) U.S. Cl. 508/108

(57) ABSTRACT

Lubricated surfaces, lubricant compositions for lubricating a surface, and methods for reducing friction coefficients in lubricants. The lubricated surface is provided by a lubricant composition containing a base oil of lubricating viscosity and an amount of at least one hydrocarbon soluble zinc compound devoid of phosphorus that is effective to provide a reduction in the coefficient of friction of the lubricant composition greater than a reduction in the coefficient of friction of the lubricant composition devoid of the hydrocarbon soluble zinc compound.

### TECHNICAL FIELD

The embodiments described herein relate to particular ash-containing oil soluble metal additives and use of such metal additives in lubricant oil formulations, and in particular to oil soluble zinc additives used as friction modifiers for lubricant formulations.

### BACKGROUND

Lubricating oils used in passenger cars and heavy duty diesel engines have changed over the years. Today's engines are designed to run hotter and harder than in the past. Various additives have been added to lubricant formulations in order to reduce friction between moving parts. One particularly common additive is the organo-molybdenum additive. While such molybdenum additives are particularly useful as friction modifiers, such molybdenum friction modifiers may have one or more of the following disadvantages: poor oil solubility; copper and/or lead corrosion; color darkening of the finished lubricant; and increased levels of sulfur and/or phosphorus in the finished lubricant.

Future generations of passenger car motor oils and heavy duty diesel engine oils require lower levels of phosphorus and sulfur in the finished oil in order to protect pollution control devices as it is well known that sulfur and phosphorus containing additives may poison or otherwise reduce the effectiveness of pollution control devices. For example, current GF-4 motor oil specifications require a finished oil to contain less than 0.08 wt % and 0.7 wt % phosphorus and sulfur, respectively, and PC-10 motor oil specifications, the next generation heavy duty diesel engine oil, requires oils to contain less than 0.12 wt % and 0.4 wt % phosphorus and sulfur, respectively, and 1.0 wt % sulfated ash. Certain molybdenum additives known in the industry contain phosphorus and sulfur at levels which reduce the effectiveness of pollution control devices.

Therefore, a need exists for lubricant additives and compositions that provide enhanced friction reducing properties and which are more compatible with pollution control devices used for automotive and diesel engines. A need also exists for such lubricant additives and compositions which are more compatible with such pollution control devices without adversely affecting oil solubility, corrosion, and/or darkening the color of the finished lubricant. Such additives may contain phosphorus and/or sulfur or may be substantially devoid of phosphorus and/or sulfur.

### SUMMARY OF THE EMBODIMENTS

In one embodiment herein is presented a lubricated surface containing a lubricant composition comprising a base oil of lubricating viscosity and an amount of at least one hydrocarbon soluble zinc compound devoid of phosphorus that is effective to provide a reduction in the coefficient of friction of the lubricant composition greater than a reduction in the coefficient of friction of the lubricant composition devoid of the hydrocarbon soluble zinc compound.

In another embodiment, there is provided a vehicle having moving parts and containing a lubricant for lubricating the moving parts. The lubricant comprises an oil of lubricating viscosity having therein first and second friction modifiers. The first friction modifier is an ashless friction modifiers. The second friction modifier contains an amount of at least one hydrocarbon soluble zinc compound devoid of phosphorus that is effective to provide a reduction in the friction coefficient of the lubricant composition greater than a reduction in the friction coefficient of the lubricant composition devoid of the hydrocarbon soluble zinc compound.

In yet another embodiment there is provided a fully formulated lubricant composition comprising a base oil component of lubricating viscosity having therein first and second friction modifiers. The first friction modifier is an ashless friction modifier. The second friction modifier contains an amount of hydrocarbon soluble zinc-containing compound effective to provide a reduction in the friction coefficient of the lubricant composition greater than a reduction in the friction coefficient of the lubricant composition devoid of the hydrocarbon soluble zinc-containing compound. The zinc-containing compound used as the second friction modifier is essentially devoid of phosphorus atoms.

A further embodiment of the disclosure provides a method of lubricating moving parts with a lubricating oil. The method includes using as the lubricating oil for one or more moving parts a lubricant composition comprising a base oil having therein first and second friction modifiers. The first friction modifier is an ashless friction modifier. The second friction modifier is a reaction product of a zinc oxide and a about C₆ to about C₃₆ carboxylic acid. As used therein, the second friction modifier is effective to provide from above about 500 to about 1000 parts per million zinc in the lubricating oil.

As set forth briefly above, embodiments of the disclosure provide a hydrocarbon soluble zinc compound that may significantly improve the coefficient of friction of a lubricant composition and may enable a decrease in the amount of phosphorus and/or sulfur additives required for equivalent friction improving characteristics. The additive may be mixed with an oleaginous fluid that is applied to a surface between moving parts. In other applications, the additive may be provided in a fully formulated lubricant composition. The additive is particularly directed to meeting the currently proposed GF-4 standards for passenger car motor oils and PC-10 standards for heavy duty diesel engine oils, as well as future passenger car and diesel engine oil specifications and standards.

The compositions and methods described herein are particularly suitable for maintaining the effectiveness of pollution control devices on motor vehicles or, in the alternative, the compositions and methods are suitable for improving the friction coefficient characteristics of lubricant formulations. Other features and advantages of the compositions and methods described herein may be evident by reference to the following detailed description which is intended to exemplify aspects of the embodiments without intending to limit the embodiments described herein.

It is to be understood that both the foregoing general description and the following detailed description are exemplary and explanatory only and are intended to provide further explanation of the embodiments disclosed and claimed.

### DETAILED DESCRIPTION OF EMBODIMENTS

In one embodiment is presented a novel composition useful as a component in lubricating oil compositions. The composition comprises a hydrocarbon soluble zinc compound that may be used in addition to or as a partial or total replacement for conventional friction modifiers containing phosphorus and/or sulfur.

The primary component of the additives and concentrates provided for lubricant compositions is the hydrocarbon soluble zinc compound. The term “hydrocarbon soluble” means that the compound is substantially suspended or dissolved in a hydrocarbon material, as by reaction or complexation of a reactive zinc compound with a hydrocarbon material. As used herein, “hydrocarbon” means any of a vast number of compounds containing carbon, hydrogen, and/or oxygen in various combinations.

The term “hydrocarbyl” refers to a group having a carbon atom attached to the remainder of the molecule and having predominantly hydrocarbon character. Examples of hydrocarbyl groups include:
[a] hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form an alicyclic radical);
[b] substituted hydrocarbon substituents, that is, substituents containing non-hydrocarbon groups which, in the context of the description herein, do not alter the predominantly hydrocarbon substituent (e.g., halo (especially chloro and fluoro), hydroxy, alkoxy, mercapto, alkylmercapto, nitro, nitroso, and sulfoxy);
[c] hetero-substituents, that is, substituents which, while having a predominantly hydrocarbon character, in the context of this description, contain other than carbon in a ring or chain otherwise composed of carbon atoms. Hetero-atoms include sulfur, oxygen, nitrogen, and encompass substituents such as pyridyl, furyl, thienyl and imidazolyl. In general, no more than two, preferably no more than one, non-hydrocarbon substituent will be present for every ten carbon atoms in the hydrocarbyl group; typically, there will be no non-hydrocarbon substituents in the hydrocarbyl group.

The hydrocarbon soluble zinc compounds suitable for use as a friction modifier are provided by a reaction product of a zinc oxide and a about C₆ to about C₃₆ carboxylic acid. The reaction product may be represented by the following formula:

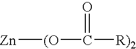

wherein R is a saturated or unsaturated hydrocarbyl group containing from about 6 to about 36 carbon atoms. Compounds of the foregoing formula are essentially devoid of phosphorous and sulfur.

In an embodiment, the hydrocarbon soluble zinc compound may be substantially or essentially devoid or free of sulfur and phosphorus atoms such that a lubricant or formulated lubricant package comprising the hydrocarbon soluble zinc compound contains about 0.7 wt % or less sulfur and about 0.12 wt % or less phosphorus.

In another embodiment, the hydrocarbon soluble zinc compound may be substantially free of active sulfur. “Active” sulfur is sulfur which is not fully oxidized. Active sulfur further oxidizes and becomes more acidic in the oil upon use.

In yet another embodiment, the hydrocarbon soluble zinc compound may be substantially free of all sulfur. In a further embodiment, the hydrocarbon soluble zinc compound may be substantially free of all phosphorus. In a still further embodiment, the hydrocarbon soluble zinc compound may be substantially free of all sulfur and phosphorus. For example, the base oil in which the zinc compound may be dissolved in could contain relatively small amounts of sulfur, such as in one embodiment, less than about 0.5 wt % and in another embodiment, about 0.03 wt % or less sulfur (e.g., for Group II base oils), and in a still further embodiment, the amount of sulfur and/or phosphorus may be limited to an amount which is necessary to make the compound while still permitting the finished oil to meet the appropriate motor oil sulfur and/or phosphorus specifications in effect at a given time.

Examples of zinc/carboxylic acid products include, but are not limited to, zinc oxide reaction products with acids selected from the group consisting essentially of caproic acid, caprylic acid, lauric acid, myristic acid, palmitic acid, stearic acid, arachidic acid, oleic acid, erucic acid, linoleic acid, linolenic acid, cyclohexanecarboxylic acid, phenylacetic acid, benzoic acid, neodecanoic acid, C₁₂-C₃₀ alkylsuccinic acids or anhydrides and the like. A method for making zinc/carboxylic acid products is described, for example, in U.S. Pat. No. 3,367,869, the disclosure of which is incorporated herein by reference.

The hydrocarbon soluble zinc compounds of the embodiments described herein are advantageously incorporated into lubricating compositions. Accordingly, the hydrocarbon soluble zinc compounds may be added directly to the lubricating oil composition. In one embodiment, however, hydrocarbon soluble zinc compounds are diluted with a substantially inert, normally liquid organic diluent such as mineral oil, synthetic oil (e.g., ester of dicarboxylic acid), naptha, alkylated (e.g. C₁₀-C₁₃ alkyl) benzene, toluene or xylene to form a metal additive concentrate. The zinc additive concentrates usually contain from about 0% to about 99% by weight diluent oil.

In the preparation of lubricating oil formulations it is common practice to introduce the zinc additive concentrates in the form of about 1 to about 99 wt. % active ingredient concentrates in hydrocarbon oil, e.g. mineral lubricating oil, or other suitable solvent. Usually these concentrates may be added to a lubricating oil with a dispersant/inhibitor (DI) additive package and viscosity index (VI) improvers containing about 0.01 to about 50 parts by weight of lubricating oil per part by weight of the DI package to form finished lubricants, e.g., crankcase motor oils. Suitable DI packages are described, for example, in U.S. Pat. Nos. 5,204,012 and 6,034,040, the disclosures of which are herein incorporated by reference. Among the types of additives which may be included in the DI additive package are detergents, dispersants, antiwear agents, friction modifiers, seal swell agents, antioxidants, foam inhibitors, lubricity agents, rust inhibitors, corrosion inhibitors, demulsifiers, pour point depressants, viscosity index improvers, and the like. Several of these components are well known to those skilled in the art and may be used in conventional amounts with the additives and compositions described herein.

In another embodiment, the zinc additive concentrates may be top treated into a fully formulated motor oil or finished lubricant. The purpose of combining the zinc additive concentrates and DI package, of course, is to make the handling of the various materials less difficult and awkward as well as to facilitate solution or dispersion in the final blend.

Embodiments described herein provide lubricating oils and lubricant formulations in which the concentration of the hydrocarbon soluble zinc compound is relatively low, providing from about 50 to about 1500 parts per million (ppm) zinc in the finished lubricant composition. In one embodiment, the metal compound is present in the lubricating oil compositions in an amount sufficient to provide from above about 100 to about 1000 ppm zinc. In another embodiment, the amount of zinc compound in the finished lubricant is an amount that is effective to provide a reduction in the friction coefficient of the lubricant composition greater than a reduction in the friction coefficient of the lubricant composition devoid of the zinc compound. In still other embodiments, the zinc compound may be used alone or in combination with one or more conventional ashless friction modifiers. Suitable ashless friction modifiers that may be used include aminic friction modifiers and/or non-nitrogen containing friction modifiers.

Lubricant compositions made with the hydrocarbon soluble zinc additive described above are used in a wide variety of applications. For compression ignition engines and spark ignition engines, it is preferred that the lubricant compositions meet or exceed published GF-4 or API-CI-4 standards. Lubricant compositions according to the foregoing GF-4 or API-CI-4 standards include a base oil, the DI additive package, and/or a VI improver to provide a fully formulated lubricant. The base oil for lubricants according to the disclosure is an oil of lubricating viscosity selected from the group consisting essentially of mineral oils, synthetic lubricating oils, vegetable oils and mixtures thereof. Such base oils include those conventionally employed as crankcase lubricating oils for spark-ignited and compression-ignited internal combustion engines such as automobile and truck engines, marine and railroad diesel engines, and the like. Such base oils are typically classified as Group I, Group II, Group III, Group IV and Group V, as described in Table 1 below.

TABLE 1
Group I–V Base Oils

| Base Oil | % Sulfur | | % Saturates | Viscosity Index |
|---|---|---|---|---|
| Group I | >0.03 | and/or | <90 | 80–120 |
| Group II | ≦0.03 | and/or | ≧90 | 80–120 |
| Group III | ≦0.03 | and/or | ≧90 | ≧120 |
| Group IV | * | | | |
| Group V | ** | | | |

* Group IV base oils are defined as all polyalphaolefins
** Group V base oils are defined as all other base oils not included in Groups I, II, III and IV

### Dispersant Components

Dispersants contained in the DI package may include, but are not limited to, an oil soluble polymeric hydrocarbon backbone having functional groups that are capable of associating with particles to be dispersed. Typically, the dispersants comprise amine, alcohol, amide, or ester polar moieties attached to the polymer backbone often via a bridging group. Dispersants may be selected from Mannich dispersants as described, for example, in U.S. Pat. Nos. 3,697,574 and 3,736,357; ashless succinimide dispersants as described in U.S. Pat. Nos. 4,234,435 and 4,636,322; amine dispersants as described in U.S. Pat. Nos. 3,219,666, 3,565,804, and 5,633,326; Koch dispersants as described in U.S. Pat. Nos. 5,936,041, 5,643,859, and 5,627,259, and polyalkylene succinimide dispersants as described in U.S. Pat. Nos. 5,851,965; 5,853,434; and 5,792,729.

### Oxidation Inhibitor Components

Oxidation inhibitors, or antioxidants, reduce the tendency of base stocks to deteriorate in service, which deterioration can be evidenced by the products of oxidation such as sludge and varnish-like deposits that deposit on metal surfaces and by viscosity growth of the finished lubricant. Such oxidation inhibitors include, but are not limited to, hindered phenols, sulfurized hindered phenols, alkaline earth metal salts of alkylphenolthioesters having about C₅ to about C₁₂ alkyl side chains, sulfurized alkylphenols, metal salts of either sulfurized or nonsulfurized alkylphenols, for example calcium nonylphenol sulfide, ashless oil soluble phonates and sulfurized phonates, phosphosulfurized or sulfurized hydrocarbons, phosphorus esters, metal thiocarbamates, and oil soluble copper compounds as described in U.S. Pat. No. 4,867,890.

Other antioxidants that may be used include sterically hindered phenols and diarylamines, alkylated phenothiazines, sulfurized compounds, and ashless dialkyldithiocarbamates. Non-limiting examples of sterically hindered phenols include, but are not limited to, 2,6-di-tertiary butylphenol, 2,6 di-tertiary butyl methylphenol, 4-ethyl-2,6-di-tertiary butylphenol, 4-propyl-2,6-di-tertiary butylphenol, 4-butyl-2,6-di-tertiary butylphenol, 4-pentyl-2,6-di-tertiary butylphenol, 4-hexyl-2,6-di-tertiary butylphenol, 4-heptyl-2,6-di-tertiary butylphenol, 4-(2-ethylhexyl)-2,6-di-tertiary butylphenol, 4-octyl-2,6-di-tertiary butylphenol, 4-nonyl-2,6-di-tertiary butylphenol, 4-decyl-2,6-di-tertiary butylphenol, 4-undecyl-2,6-di-tertiary butylphenol, 4-dodecyl-2,6-di-tertiary butylphenol, methylene bridged sterically hindered phenols including, but not limited to, 4,4-methylenebis(6-tertbutyl-o-cresol), 4,4-methylenebis(2-tert-amyl-o-cresol), 2,2-methylenebis(4-methyl-6 tert-butylphenol, 4,4-methylene-bis(2,6-di-tert-butylphenol) and mixtures thereof as described in U.S. Publication No. 2004/0266630.

Diarylamine antioxidants include, but are not limited, to diarylamines having the formula:

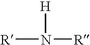

wherein R′ and R″ each independently represents a substituted or unsubstituted aryl group having from about 6 to about 30 carbon atoms. Illustrative of substituents for the aryl group, but are not limited to, include aliphatic hydrocarbon groups such as alkyl having from about 1 to about 30 carbon atoms, hydroxy groups, halogen radicals, carboxylic acid or ester groups, or nitro groups.

The aryl group is may be substituted or unsubstituted phenyl or naphthyl. In one embodiment, one or both of the aryl groups are substituted with at least one alkyl group having from about 4 to about 30 carbon atoms. In another embodiment, one or both of the aryl groups are substituted with at least one alkyl group having from about 4 to about 18 carbon atoms. In yet another embodiment, one or both of the aryl groups are substituted with at least one alkyl group having from about 4 to about 9 carbon atoms. In still yet another embodiment, one or both of the aryl groups are substituted, e.g. mono-alkylated diphenylamine, di-alkylated diphenylamine, or mixtures of mono- and di-alkylated diphenylamines.

The diarylamines may be of a structure containing more than one nitrogen atom in the molecule. Thus, the diarylamine may contain at least two nitrogen atoms wherein at least one nitrogen atom has two aryl groups attached thereto, e.g., as in the case of various diamines having a secondary nitrogen atom as well as two aryls on one of the nitrogen atoms.

Examples of diarylamines that may be used include, but are not limited to: diphenylamine; various alkylated diphenylamines; 3-hydroxydiphenylamine; N-phenyl-1,2-phenylenediamine; N-phenyl-1,4-phenylenediamine; monobutyldiphenylamine; dibutyldiphenylamine, monooctyldiphenylamine; dioctyldiphenylamine; monononyldiphenylamine; dinonyldiphenylamine; monotetradecyldiphenylamine; ditetradecyldiphenylamine, phenyl-alpha-naphthylamine; monooctyl phenyl-alpha-naphthylamine; phenyl-beta-naphthylamine; monoheptyldiphenylamine; diheptyldiphenylamine; p-oriented styrenated diphenylamine; mixed butyloctyldiphenylamine; and mixed octylstyryldiphenylamine.

Another class of aminic antioxidants includes phenothiazine or alkylated phenothiazine having the chemical formula:

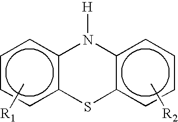

wherein R₁ is a linear or branched about C₁ to about C₂₄ alkyl, aryl, heteroalkyl or alkylaryl group and R₂ is hydrogen or a linear or branched about C₁— about C₂₄ alkyl, heteroalkyl, or alkylaryl group. Alkylated phenothiazine may be selected from the group consisting essentially of monotetradecylphenothiazine, ditetradecylphenothiazine, monodecylphenothiazine, didecylphenothiazine, monononylphenothiazine, dinonylphenothiazine, monoctyl-phenothiazine, dioctylphenothiazine, monobutylphenothiazine, dibutylphenothiazine, monostyrylphenothiazine, distyrylphenothiazine, butyloctylphenothiazine, and styryloctylphenothiazine.

The sulfur containing antioxidants include, but are not limited to, sulfurized olefins that are characterized by the type of olefin used in their production and the final sulfur content of the antioxidant. In one embodiment, high molecular weight olefins, i.e. those olefins having an average molecular weight of about 168 to about 351 g/mole, may be used. Non-limiting examples of olefins that may be used include alpha-olefins, isomerized alpha-olefins, branched olefins, cyclic olefins, and combinations of these.

Alpha-olefins include, but are not limited to, any about C₄ to about C₂₅ alpha-olefins. Alpha-olefins may be isomerized before the sulfurization reaction or during the sulfurization reaction. Structural and/or conformational isomers of the alpha olefin that contain internal double bonds and/or branching may also be used. For example, isobutylene is a branched olefin counterpart of the alpha-olefin 1-butene.

Sulfur sources that may be used in the sulfurization reaction of olefins include: elemental sulfur, sulfur monochloride, sulfur dichloride, sodium sulfide, sodium polysulfide, and mixtures of these added together or at different stages of the sulfurization process.

Unsaturated oils, because of their unsaturation, may also be sulfurized and used as an antioxidant. Examples of oils or fats that may be used include corn oil, canola oil, cottonseed oil, grapeseed oil, olive oil, palm oil, peanut oil, coconut oil, rapeseed oil, safflower seed oil, sesame seed oil, soybean oil, sunflower seed oil, tallow, and combinations of these.

The amount of sulfurized olefin or sulfurized fatty oil delivered to the finished lubricant is based on the sulfur content of the sulfurized olefin or fatty oil and the desired level of sulfur to be delivered to the finished lubricant. For example, a sulfurized fatty oil or olefin containing about 20 weight % sulfur, when added to the finished lubricant at an approximately 1.0 weight % treat level, will deliver 2,000 ppm of sulfur to the finished lubricant. A sulfurized fatty oil or olefin containing about 10 weight % sulfur, when added to the finished lubricant at an approximately 1.0 weight % treat level, will deliver 1,000 ppm sulfur to the finished lubricant. In one embodiment, the sulfurized olefin or sulfurized fatty oil is added to deliver between about 200 ppm and about 2,000 ppm sulfur to the finished lubricant. The foregoing aminic, phenothiazine, and sulfur containing antioxidants are described, for example, in U.S. Pat. No. 6,599,865.

The ashless dialkyldithiocarbamates which may be used as antioxidant additives include, but are not limited to, compounds that are soluble or dispersible in the additive package. In one embodiment, the ashless dialkyldithiocarbamate may be of low volatility, and may have a molecular weight greater than about 250 Daltons. In yet another embodiment, the ashless dialkyldithiocarbamate may a molecular weight greater than about 400 Daltons. Examples of ashless dithiocarbamates that may be used include, but are not limited to, methylenebis(dialkyldithiocarbamate), ethylenebis(dialkyldithiocarbamate), isobutyl disulfide-2,2′-bis(dialkyldithiocarbamate), hydroxyalkyl substituted dialkyldithio-carbamates, dithiocarbamates prepared from unsaturated compounds, dithiocarbamates prepared from norbornylene, and dithiocarbamates prepared from epoxides. In an embodiment, the alkyl groups of the dialkyldithiocarbamate may have from about 1 to about 16 carbons. Non-limiting examples of dialkyldithiocarbamates that may be used are disclosed in the following patents: U.S. Pat. Nos. 5,693,598; 4,876,375; 4,927,552; 4,957,643; 4,885,365; 5,789,357; 5,686,397; 5,902,776; 2,786,866; 2,710,872; 2,384,577; 2,897,152; 3,407,222; 3,867,359; and 4,758,362.

Further examples of ashless dithiocarbamates may include, but are not limited to: methylenebis-(dibutyldithiocarbamate), ethylenebis(dibutyldithiocarbamate), isobutyl disulfide-2,2′-bis(dibutyldithiocarbamate), dibutyl-N,N-dibutyl(dithiocarbamyl)succinate, 2-hydroxypropyl dibutyldithiocarbamate, Butyl(dibutyldithiocarbamyl)acetate, and S-carbomethoxy-ethyl-N,N-dibutyl dithiocarbamate.

Zinc dialkyl dithiophosphates (“Zn DDPs”) may also used in lubricating oils. Zn DDPs have good antiwear and antioxidant properties and have been used to pass cam wear tests, such as the Seq. IVA and TU3 Wear Test. Many patents address the manufacture and use of Zn DDPs including U.S. Pat. Nos. 4,904,401; 4,957,649; and 6,114,288. Non-limiting general Zn DDP types are primary, secondary and mixtures of primary and secondary Zn DDPs

The hydrocarbon soluble metal compounds described herein may be used with any or all of the foregoing antioxidants in any and all combinations and ratios. It is understood that various combinations of phenolic, aminic, and sulfur containing additives may be optimized for the finished lubricant formulation based on bench or engine tests or modifications of the dispersant, VI improver, base oil, or any other additive.

### Ashless Friction Modifier Components

One type of ashless friction modifier that may be used is a non-nitrogen, non-molybdenum containing friction modifier, for example a glyceride. Glycerides may be used alone or in combination with other friction modifiers. Suitable glycerides include, but are not limited to, glycerides of the formula:

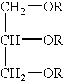

wherein each R is independently selected from the group consisting of H and C(O)R′ where R′ may be a saturated or an unsaturated alkyl group having from about 3 to about 23 carbon atoms. Non-limiting examples of glycerides that may be used include glycerol monolaurate, glycerol monomyristate, glycerol monopalmitate, glycerol monostearate, and mono-glycerides derived from coconut acid, tallow acid, oleic acid, linoleic acid, and linolenic acids. Typical commercial monoglycerides contain substantial amounts of the corresponding diglycerides and triglycerides. Any ratio of mono- to di-glyceride may be used. In an embodiment, from about 30 to about 70% of the available sites contain free hydroxyl groups (i.e., 30 to 70% of the total R groups of the glycerides represented by the above formula are hydrogen). In another embodiment, the glyceride is glycerol monooleate, which is generally a mixture of mono, di, and tri-glycerides derived from oleic acid, and glycerol.

Other suitable ashless friction modifiers include, but are not limited to, aliphatic amines or ethoxylated aliphatic amines, ether amines, alkoxylated ether amines, aliphatic fatty acid amides, aliphatic carboxylic acids, aliphatic carboxylic esters, aliphatic carboxylic ester-amides, imidazolines, tertiary amines, aliphatic phosphonates, aliphatic phosphates, aliphatic thiophosphonates, aliphatic thiophosphates, etc., wherein the aliphatic group usually contains above about eight carbon atoms so as to render the compound suitably oil soluble. Also suitable are aliphatic substituted succinimides formed by reacting one or more aliphatic succinic acids or anhydrides with ammonia primary amines.

The succinimide may include the reaction product of a succinic anhydride and ammonia or primary amine. The alkenyl group of the alkenyl succinic acid may be a short chain alkenyl group, for example, the alkenyl group may include from about 12 to about 36 carbon atoms. Further, the succinimide may include a C₁₂ to about C₃₆ aliphatic hydrocarbyl succinimide. As a further example, the succinimide may include a C₁₆ to about C₂₈ aliphatic hydrocarbyl succinimide. As an even further example, the succinimide may include a C₁₈ to about C₂₄ aliphatic hydrocarbyl succinimide.

One particularly suitable group of friction modifiers includes the N-aliphatic hydrocarbyl-substituted diethanol amines in which the N-aliphatic hydrocarbyl-substituent is at least one straight chain aliphatic hydrocarbyl group free of acetylenic unsaturation and having in the range of about 14 to about 20 carbon atoms.

Generally speaking, the compositions of this invention will contain up to about 1.25 wt %, and preferably from about 0.05 to about 1 wt % of one or more friction modifiers.

### Other Components

Rust inhibitors selected from the group consisting essentially of nonionic polyoxyalkylene polyols and esters thereof, polyoxyalkylene phenols, and anionic alkyl sulfonic acids may be used.

A small amount of a demulsifying component may be used. A preferred demulsifying component is described in EP Pat. No. 330,522, the disclosure of which is herein incorporated by reference. Such demulsifying component may be obtained by reacting an alkylene oxide with an adduct obtained by reacting a bis-epoxide with a polyhydric alcohol. The demulsifier should be used at a level not exceeding 0.1 mass % active ingredient. In an embodiment, a treat rate of about 0.001 to about 0.05 mass % active ingredient may be used.

Pour point depressants, otherwise known as lube oil flow improvers, lower the minimum temperature at which the fluid will flow or can be poured. Such additives are well known. Non-limiting examples of pour point depressant additives which improve the low temperature fluidity of the fluid are about C₈ to about C₁₈ dialkyl fumarate/vinyl acetate copolymers, polyalkylmethacrylates and the like.

Foam control can be provided by many compounds including, but not limited to, an antifoamant of the polysiloxane type, for example, silicone oil or polydimethyl siloxane.

Seal swell agents, as described, but not limited to, for example, in U.S. Pat. Nos. 3,794,081 and 4,029,587, may also be used.

Viscosity modifiers (VM) function to impart high and low temperature operability to a lubricating oil. The VM used may have that sole function, or may be multifunctional.

Multifunctional viscosity modifiers that also function as dispersants are also known. Non-limiting examples of suitable viscosity modifiers are polyisobutylene, copolymers of ethylene and propylene and higher alpha-olefins, polymethacrylates, polyalkylmethacrylates, methacrylate copolymers, copolymers of an unsaturated dicarboxylic acid and a vinyl compound, inter polymers of styrene and acrylic esters, and partially hydrogenated copolymers of styrene/isoprene, styrene/butadiene, and isoprene/butadiene, as well as the partially hydrogenated homopolymers of butadiene and isoprene and isoprene/divinylbenzene.

Functionalized olefin copolymers that may also be used include interpolymers of ethylene and propylene which are grafted with an active monomer such as maleic anhydride and then derivatized with an alcohol or amine. Other such copolymers are copolymers of ethylene and propylene which are grafted with nitrogen compounds.

Each of the foregoing additives, when used, is used at a functionally effective amount to impart the desired properties to the lubricant. Thus, for example, if an additive is a corrosion inhibitor, a functionally effective amount of this corrosion inhibitor would be an amount sufficient to impart the desired corrosion inhibition characteristics to the lubricant. Generally, the concentration of each of these additives, when used, ranges up to about 20% by weight based on the weight of the lubricating oil composition, and in one embodiment from about 0.001% to about 20% by weight, and in one embodiment about 0.01% to about 10% by weight based on the weight of the lubricating oil composition.

The hydrocarbon soluble zinc additives may be added directly to the lubricating oil composition. In one embodiment, however, they are diluted with a substantially inert, normally liquid organic diluent such as mineral oil, synthetic oil, naphtha, alkylated (e.g. C₁₀ to C₁₃ alkyl) benzene, toluene or xylene to form an additive concentrate. These concentrates usually contain from about 1% to about 100% by weight and in one embodiment about 10% to about 90% by weight of the zinc compound.

Base Oils

Base oils suitable for use in formulating the compositions, additives and concentrates described herein may be selected from any of the synthetic, natural and mineral oils, or mixtures thereof. Non-limiting examples of synthetic base oils include alkyl esters of dicarboxylic acids, polyglycols and alcohols, poly-alpha-olefins, including polybutenes, alkyl benzenes, organic esters of phosphoric acids, polysilicone oils, and alkylene oxide polymers, interpolymers, copolymers and derivatives thereof where the terminal hydroxyl groups have been modified by esterification, etherification, and the like.

Natural base oils include, but are not limited to, animal oils and vegetable oils (e.g., castor oil, lard oil), liquid petroleum oils and hydrorefined, solvent-treated or acid-treated mineral lubricating oils of the paraffinic, naphthenic and mixed paraffinic-naphthenic types. Oils of lubricating viscosity derived from coal or shale are also useful base oils. In an embodiment, the base oil typically has a viscosity of about 2.5 to about 15 cSt. In another embodiment, the base oil has a viscosity of about 2.5 to about 11 cSt at 100° C. Such base oils include those conventionally employed as crankcase lubricating oils for spark-ignited and compression-ignited internal combustion engines, such as automobile and truck engines, marine and railroad diesel engines, and the like. These base oils are typically classified as Group I, Group II, Group III Group IV and Group V. The above mentioned base oils are described above in Table 1.

The following examples are given for the purpose of exemplifying aspects of the embodiments and are not intended to limit the embodiments in any way.

### EXAMPLE 1

### Synthesis of Zinc Oleate

Zinc Oleate was made by charging 423 grams of oleic acid and 1.5 grams of acetic acid (as a catalyst) to a flask equipped with a sub-surface nitrogen sparge and a Dean-Stark trap. The acid mixture was heated to 50° C. and then 73 grams of zinc oxide were added to the flask in portions over a one hour period. The temperature of the mixture in the flask was then raised to 150° C. and held there for six hours. The Dean-Stark trap was replaced with a distillation condenser and the batch was vacuum stripped at 150° C. over a two hour period. The product was then filtered over a paper filter media. The filtered product contained 11.6 wt. % zinc and had a total acid number (TAN) of 2.1.

Zince oleate is also commercially available from Monomer-Polymer Dajac Labs, Inc. of Feasterville, Pa.

### EXAMPLE 2

### Friction Coefficient Effects of Hydrocarbon Soluble Zinc Additives

In the following example, zinc oleate was added to a GF-4 formulated lubricant composition to provide zinc metal in amount of about 300 or about 600 ppm based on the finished lubricant. Combinations of the lubricant with and without a second friction modifier compound were also prepared and tested. The boundary friction coefficients on steel were determined at about 130° C. in a high frequency reciprocating test rig run under a load of 400 grams at 20 Hz. The finished lubricant had a kinematic viscosity at about 100° C. of about 8.55 cSt, a cold crank start viscosity (CCS) of about 3,752 centipoise at about −30° C., and contained the following components in the approximate amounts indicated in the following table:

TABLE 2
Finished Lubricant

| | Amount | Amount | Amount |
|---|---|---|---|
| Component | (wt. %) | (wt. %) | (wt. %) |
| Base detergent/dispersant package | 17.0 | 16.7 | 16.4 |
| Zinc oleate | — | 0.3 | 0.6 |
| Group II, 110 N, Base Oil | 5.0 | 5.0 | 5.0 |
| Group II, 225 N, Base Oil | 5.0 | 5.0 | 5.0 |
| Group III base oil | 73.0 | 73.0 | 73.0 |
| Total | 100.0 | 100.0 | 100.0 |

The following table lists the results of the friction tests using no friction modifier and with different amounts of the zinc oleate as provided in the formulations of table 2.

TABLE 3
Friction Data for Finished Oil

| Run | | Friction |
|---|---|---|
| No. | | Coefficient |
| 1 | No zinc oleate | 0.122 |
| 2 | Zinc oleate (0.3 wt. %) | 0.103 |
| 3 | Zinc oleate (0.6 wt. %) | 0.073 |

As seen by the results in Table 3, zinc oleate (Runs 2 and 3) provided significant reductions in the friction coefficient of the lubricant as compared to the base oil (Run 1) that contained no friction modifier.

It is expected that formulations containing from about 50 to about 1500 ppm or more zinc metal in the form of a hydrocarbon soluble zinc compound devoid of phosphorus and sulfur will enable a reduction in conventional phosphorus and sulfur antiwear agents thereby maintaining the effectiveness the performance of pollution control equipment on vehicles while achieving a similar or improved friction coefficient performance or benefit and little or no adverse effect on the corrosiveness of the oil.

At numerous places throughout this specification, reference has been made to a number of U.S. patents and publications. All such cited documents are expressly incorporated in full into this disclosure as if fully set forth herein.

The foregoing embodiments are susceptible to considerable variation in its practice. Accordingly, the embodiments are not intended to be limited to the specific exemplifications set forth hereinabove. Rather, the foregoing embodiments are within the spirit and scope of the appended claims, including the equivalents thereof available as a matter of law.

The patentees do not intend to dedicate any disclosed embodiments to the public, and to the extent any disclosed modifications or alterations may not literally fall within the scope of the claims, they are considered to be part hereof under the doctrine of equivalents.

What is claimed is:

1. A lubricated surface comprising a lubricant composition containing a base oil of lubricating viscosity and an amount of at least one hydrocarbon soluble zinc compound devoid of phosphorus and effective to provide a reduction in the coefficient of friction of the lubricant composition greater than a reduction in the coefficient of friction of the lubricant composition devoid of the hydrocarbon soluble zinc compound.

2. The lubricated surface of claim 1, wherein the lubricated surface comprises an engine drive train.

3. The lubricated surface of claim 1, wherein the lubricated surface comprises an internal surface or component of an internal combustion engine.

4. The lubricated surface of claim 1, wherein the lubricated surface comprises an internal surface or component of a compression ignition engine.

5. The lubricated surface of claim 1, wherein the amount of hydrocarbon soluble zinc compound provides an amount of zinc ranging from about 50 to about 1500 ppm in the lubricant composition.

6. The lubricated surface of claim 1, wherein the hydrocarbon soluble zinc compound comprises a zinc carboxylate.

7. The lubricated surface of claim 1, wherein the hydrocarbon soluble zinc compound is devoid of phosphorus and sulfur.

8. The lubricated surface of claim 1, wherein the hydrocarbon soluble zinc compound comprises a zinc carboxylate derived from a mono- or di-carboxylic acid containing at least about 6 carbon atoms and having a primary, secondary, or tertiary carbon adjacent to a carboxyl group.

9. The lubricated surface of claim 1, wherein the hydrocarbon soluble zinc compound is a compound of the structure 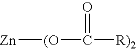
wherein R is a saturated or unsaturated hydrocarbyl group containing from about 6 to about 36 carbon atoms.

10. A motor vehicle comprising the lubricated surface of claim 1.

11. The vehicle of claim 10, wherein the amount of hydrocarbon soluble zinc compound provides from about 50 to about 1500 parts per million zinc in the lubricant.

12. A vehicle having moving parts and containing a lubricant for lubricating the moving parts, the lubricant comprising an oil of lubricating viscosity, a first ashless friction modifier, and a second friction modifier comprising an amount of at least one hydrocarbon soluble zinc compound effective to provide a reduction in the friction coefficient of the lubricant composition greater than a reduction in the friction coefficient of the lubricant composition devoid of the hydrocarbon soluble zinc compound, wherein the zinc compound is essentially devoid of phosphorus atoms.

13. The vehicle of claim 12, wherein the hydrocarbon soluble zinc compound comprises a zinc- about C₆ to about C₃₆ carboxylate.

14. The vehicle of claim 12, wherein the hydrocarbon soluble zinc compound comprises a compound of the structure 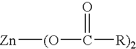
wherein R is a saturated or unsaturated hydrocarbyl group containing from about 6 to about 36 carbon atoms.

15. The vehicle of claim 12, wherein the moving parts comprise a heavy duty diesel engine.

16. A fully formulated lubricant composition comprising a base oil component of lubricating viscosity, a first ashless friction modifier and a second friction modifier comprising an amount of hydrocarbon soluble zinc-containing compound effective to provide a reduction in the coefficient of friction of the lubricant composition greater than a reduction in the coefficient of friction of the lubricant composition devoid of the hydrocarbon soluble zinc-containing compound, wherein the zinc-containing compound is essentially devoid of phosphorus atoms.

17. The lubricant composition of claim 16 wherein the lubricant composition comprises a low ash, low sulfur, and low phosphorus lubricant composition suitable for compression ignition engines such that the finished oil contains about 0.7 wt % or less sulfur and about 0.12 wt % or less phosphorus.

18. The lubricant composition of claim 16, wherein the hydrocarbon soluble zinc-containing agent comprises a zinc- about C₆ to about C₃₆ carboxylate.

19. The vehicle of claim 16, wherein the hydrocarbon soluble zinc-containing agent comprises a compound of the structure 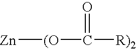
wherein R is a saturated or unsaturated hydrocarbyl group containing from about 6 to about 36 carbon atoms.

20. The lubricant composition of claim 16, wherein the amount of hydrocarbon soluble zinc-containing compound provides from about 50 to about 1500 parts per million zinc to the lubricant composition.

21. A method of reducing the friction coefficient of engine lubricant compositions during operation of an engine containing the lubricant composition, comprising contacting the engine parts with a lubricant composition comprising a base oil of lubricating viscosity and an amount of a hydrocarbon soluble zinc compound devoid of phosphorus that is effective to provide a reduction in the friction coefficient of the lubricant composition greater than a reduction in the friction coefficient of the lubricant composition devoid of the hydrocarbon soluble zinc compound.

22. The method of claim 21 wherein the engine comprises a heavy duty diesel engine.

23. The method of claim 21, wherein the hydrocarbon soluble zinc compound comprises a zinc- about C₆— about C₃₆— carboxylate, wherein the hydrocarbon soluble zinc compound is substantially devoid of phosphorus atoms.

24. The method of claim 21, wherein the lubricant composition further comprises a second friction modifier selected from the group consisting essentially of an amine friction modifier, a glycerol ester friction modifier, and a mixture thereof.

25. A method of lubricating moving parts with a lubricating oil, the method comprising using as the lubricating oil for one or more moving parts a lubricant composition containing a base oil, a first ashless friction modifier, and a second friction modifier comprising a reaction product of a zinc oxide and a about C₆ to about C₃₆ carboxylic acid, wherein the second friction modifier is effective to provide from above about 500 to about 1000 parts per million zinc in the lubricating oil.

26. The method of claim 25, wherein the moving parts comprise moving parts of an engine.

27. The method of claim 26, wherein the engine is selected from the group consisting essentially of a compression ignition engine and a spark ignition engine.

28. The method of claim 26 wherein the engine includes an internal combustion engine having a crankcase and wherein the lubricating oil comprises a crankcase oil present in the crankcase of the engine.

29. The method of claim 26, wherein the lubricating oil comprises a drive train lubricant present in a drive train of a vehicle containing the engine.
